(19) United States
(12) Patent Application Publication
(10) Pub. No.: US 2018/0115787 A1
(43) Pub. Date: Apr. 26, 2018

(54) METHOD FOR ENCODING AND DECODING VIDEO SIGNAL, AND APPARATUS THEREFOR

(71) Applicant: LG Electronics Inc., Seoul (KR)

(72) Inventors: Moonmo KOO, Seoul (KR); Sehoon YEA, Seoul (KR); Kyuwoon KIM, Seoul (KR); Bumshik LEE, Seoul (KR)

(21) Appl. No.: 15/565,823

(22) PCT Filed: Apr. 12, 2016
(86) PCT No.: PCT/KR2016/003834

§ 371 Date: Oct. 11, 2017

Related U.S. Application Data
(60) Provisional application No. 62/146,391, filed on Apr. 12, 2015.

(51) Int. Cl. H04N 19/593; H04N 19/124; H04N 19/182; H04N 19/61

(52) U.S. Cl. CPC H04N 19/593; H04N 19/61; H04N 19/182; H04N 19/124

(57) ABSTRACT

The present invention provides a method for encoding a video signal, comprising: generating prediction pixels for the first row or column of a current block on the basis of boundary pixels neighboring to the current block; predicting remaining pixels within the current block respectively in the vertical direction or horizontal direction using the prediction pixels for the first row or column of the current block; generating a difference signal on the basis of the prediction pixels for the current block; and generating a transform-coded residual signal by applying a horizontal transform matrix and a vertical transform matrix to the difference signal.

### CROSS-REFERENCE TO RELATED APPLICATIONS

This application is the National Stage filing under 35 U.S.C. 371 of International Application No. PCT/KR2016/003834, filed on Apr. 12, 2016, which claims the benefit of U.S. Provisional Application No. 62/146,391, filed on Apr. 12, 2015, the contents of which are all hereby incorporated by reference herein in their entirety.

### TECHNICAL FIELD

The present invention relates to a method and apparatus for encoding and decoding a video signal and, more particularly, to a separable conditionally non-linear transform (hereinafter referred to as an “SCNT”) technology.

### BACKGROUND ART

Compression coding means a set of signal processing techniques for sending digitalized information through a communication line or storing digitalized information in a form suitable for a storage medium. Media, such as videos, images, and voice may be the subject of compression coding. In particular, a technique for performing compression coding on videos is called video compression.

Many media compression techniques are based on two types of approaches called predictive coding and transform coding. In particular, a hybrid coding technique adopts a method of combining advantages of both predictive coding and transform coding for video coding, but each of the coding techniques has the following disadvantages.

In the case of predictive coding, any statistical dependency may not be used in obtaining predictive error samples. That is, predictive coding is based on a method of predicting signal components using parts of the same signal that have already been coded and coding the numerical difference between predicted and actual value. More specifically, predictive coding follows from information theory that predicted signals can be compressed more efficiently and may obtain a better compression effect by increasing the consistency and accuracy of prediction. Predictive coding is advantageous in processing non-smooth or non-stationary signals because it is based on causal statistics relationships, but is disadvantageous in that it is inefficient in processing signals at large scales. Furthermore, predictive coding is disadvantageous in that it may not use limitations of the human visual and auditory systems because quantization is applied to the original video signal.

Meanwhile, orthogonal transform, such as discrete cosine transform or discrete wavelet transform, may be used in transform coding. Transform coding is a technique for decomposing a signal into a set of components in order to identify the most important data. Most of the transform coefficients are 0 after quantization. However, transform coding is disadvantageous in that it must depend on the first available data in obtaining the predictive value of samples. This makes it difficult for a prediction signal to have high quality.

### DISCLOSURE

### Technical Problem

The present invention is to propose a method of performing prediction using the most recently reconstructed data.

Furthermore, the present invention is to provide method of applying a conditionally non-linear transform algorithm (CNT) using N×N transform by restricting a prediction direction.

Furthermore, the present invention is to provide a conditionally non-linear transform (CNT) algorithm for sequentially applying N×N transform to the rows and columns of a N×N block.

Furthermore, the present invention is to provide a method of generating the prediction signal of the first line (row, column) of a current block using neighboring pixels.

Furthermore, the present invention is to propose a method of reconstructing a current block based on the prediction signal of the first line (row, column) of a current block.

Furthermore, the present invention is to propose a method of encoding/decoding a current block using separable conditionally non-linear transform (SCNT).

Furthermore, the present invention is to propose a method of applying both the advantages of each coding method based on the convergence of new prediction/transform coding.

The present invention is to replace linear/non-linear prediction coding, combined with transform coding, with an integrated non-linear transform block.

The present invention is to propose a method of more efficiently coding a high picture-quality video including a non-smooth non-stationary signal.

### Technical Solution

The present invention provides a conditionally nonlinear transform (“CNT”) method in which a correlation between pixels on a domain is taken into consideration.

Furthermore, the present invention provides a method of applying a conditionally non-linear transform algorithm (CNT) using N×N transform by restricting a prediction direction.

Furthermore, the present invention provides a conditionally non-linear transform algorithm (CNT) in which N×N transform is sequentially applied to the rows and columns of a N×N block.

Furthermore, the present invention provides a method of generating the prediction signal of the first line (row, column) of a current block using neighboring pixels.

Furthermore, the present invention provides a method of reconstructing a current block based on the prediction signal of the first line (row, column) of a current block.

Furthermore, the present invention provides a method of encoding/decoding a current block using separable conditionally non-linear transform (SCNT).

Furthermore, the present invention provides a method of obtaining an optimized transform coefficient by taking into consideration all of previously reconstructed signals when performing a prediction process.

### Advantageous Effects

The present invention can apply a N×N transform matrix to a N×N block instead of an N²×N² transform matrix by restricting the direction in which reference is made to a reconstructed pixel to any one of horizontal and vertical directions with respect to all of pixel positions, and thus can reduce a computational load and a memory space for storing a transform coefficient.

Furthermore, a neighbor and reconstructed pixel to which reference is made is a value already reconstructed using a residual signal, and thus a pixel that refers to the reconstructed pixel at the current position has very low association with a prediction mode. Accordingly, the precision of prediction can be significantly improved by taking into consideration a prediction mode with respect to the first line of a current block only and using a reconstructed pixel neighboring in the horizontal or vertical direction with respect to the remaining pixels.

Furthermore, the present invention can improve compression efficiency using conditionally nonlinear transform by taking into consideration a correlation between pixels on the domain.

Furthermore, the present invention can take all the advantages of each coding method by converging prediction coding and transform coding. That is, more fine and improved prediction can be performed using all of previously reconstructed signals, and the statistical dependency of a prediction error sample can be used. Furthermore, a high-picture quality image including a non-smooth non-stationary signal can be efficiently coded by applying prediction and transform to a single dimension at the same time.

Furthermore, a prediction error included in a prediction error vector can also be controlled because each of decoded transform coefficients affects the entire reconstruction process. That is, a quantization error propagation problem is solved because a prediction error is controlled by taking into consideration a quantization error.

The present invention enables signal adaptive decoding without a need for additional information and enables high-picture quality prediction and can also reduce a prediction error compared to the existing hybrid coder.

### DESCRIPTION OF DRAWINGS

FIGS. 1 and 2 illustrate schematic block diagrams of an encoder and a decoder in which media coding is performed.

FIGS. 3 and 4 are embodiments to which the present invention may be applied and are schematic block diagrams illustrating an encoder and a decoder to which an advanced coding method may be applied.

FIG. 5 is an embodiment to which the present invention may be applied and is a schematic flowchart illustrating an advanced video coding method.

FIG. 6 is an embodiment to which the present invention may be applied and is a flowchart illustrating an advanced video coding method for generating an optimized prediction signal.

FIG. 7 is an embodiment to which the present invention may be applied and is a flowchart illustrating a process of generating an optimized prediction signal.

FIG. 8 is an embodiment to which the present invention may be applied and is a flowchart illustrating a method of obtaining an optimized transform coefficient.

FIGS. 9 and 10 are embodiments to which the present invention is applied and are conceptual diagrams for illustrating a method of applying spatiotemporal transform on a group of picture (GOP).

FIGS. 11 and 12 are embodiments to which the present invention is applied and are diagrams for illustrating a method of generating the prediction signal of the first line (row, column) of a current block using neighboring pixels.

FIGS. 13 and 14 are embodiments to which the present invention is applied and are diagrams for illustrating a method of reconstructing a current block based on the prediction signal of the first line (row, column) of a current block.

FIG. 15 is an embodiment to which the present invention is applied and is a flowchart for illustrating a method of encoding a current block using separable conditionally non-linear transform (SCNT).

FIG. 16 is an embodiment to which the present invention is applied and is a flowchart for illustrating a method of decoding a current block using separable conditionally non-linear transform (SCNT).

### BEST MODE

The present invention provides a method of encoding a video signal, including the steps of generating prediction pixels for the first row or column of a current block based on a boundary pixel neighboring to the current block; predicting the remaining pixels within the current block respectively in a vertical direction or a horizontal direction using the prediction pixels for the first row or column of the current block; generating a difference signal based on the prediction pixels of the current block; and generating a transform-coded residual signal by applying a horizontal-directional transform matrix and a vertical-directional transform matrix to the difference signal.

In the present invention, when the prediction pixels for the first row of the current block are generated, the prediction for the remaining pixels is performed based on a previously reconstructed pixel in the vertical direction.

In the present invention, when the prediction pixels for the first column of the current block are generated, the prediction for the remaining pixels is performed based on a previously reconstructed pixel in the horizontal direction.

The present invention further includes the steps of performing quantization on the transform-coded residual signal and performing entropy encoding on the quantized residual signal.

In the present invention, rate-distortion optimized quantization is applied to the step of performing the quantization.

The present invention further includes the step of determining an intra-prediction mode of the current block, wherein the prediction pixels for the first row or column of the current block are generated based on the intra-prediction mode.

In the present invention, when the current block has a N×N size, the boundary pixel neighboring to the current block includes at least one of N samples neighboring to the left boundary of the current block, N samples neighboring to the bottom left of the current block, N samples neighboring to the top boundary of the current block, N samples neighboring to the top right of the current block, and one sample neighboring to the top left corner of the current block.

In the present invention, when the current block has a N×N size, the horizontal-directional transform matrix and the vertical-directional transform matrix are a N×N transform.

In the present invention, a method of decoding a video signal includes the steps of obtaining a transform-coded residual signal of a current block from the video signal; performing inverse transform on the transform-coded residual signal based on a vertical-directional transform matrix and a horizontal-directional transform matrix; generating a prediction signal of the current block; and generating a reconstructed signal by adding the residual signal obtained through the inverse transform and the prediction signal, wherein the transform-coded residual signal is sequentially inverse-transformed in a vertical direction and a horizontal direction.

In the present invention, the step of generating the prediction signal includes the steps of generating prediction pixels for a first row or column of the current block based on a boundary pixel neighboring to the current block; and predicting remaining pixels within the current block in the vertical direction or the horizontal direction using the prediction pixels for the first row or column of the current block.

The present invention further includes the step of obtaining an intra-prediction mode of the current block, wherein the prediction pixels for the first row or column of the current block are generated based on the intra-prediction mode.

In the present invention, when the current block has a N×N size, the horizontal-directional transform matrix and the vertical-directional transform matrix are a N×N transform.

### MODE FOR INVENTION

Hereinafter, exemplary elements and operations in accordance with embodiments of the present invention are described with reference to the accompanying drawings. The elements and operations of the present invention that are described with reference to the drawings illustrate only embodiments, which do not limit the technical spirit of the present invention and core constructions and operations thereof.

Furthermore, terms used in this specification are common terms that are now widely used, but in special cases, terms randomly selected by the applicant are used. In such a case, the meaning of a corresponding term is clearly described in the detailed description of a corresponding part. Accordingly, it is to be noted that the present invention should not be interpreted as being based on the name of a term used in a corresponding description of this specification, but should be interpreted by checking the meaning of a corresponding term.

Furthermore, terms used in this specification are common terms selected to describe the invention, but may be replaced with other terms for more appropriate analyses if other terms having similar meanings are present. For example, a signal, data, a sample, a picture, a frame, and a block may be properly replaced and interpreted in each coding process.

Furthermore, the concepts and methods of embodiments described in this specification may be applied to other embodiments, and a combination of the embodiments may be applied without departing from the technical spirit of the present invention although they are not explicitly all described in this specification.

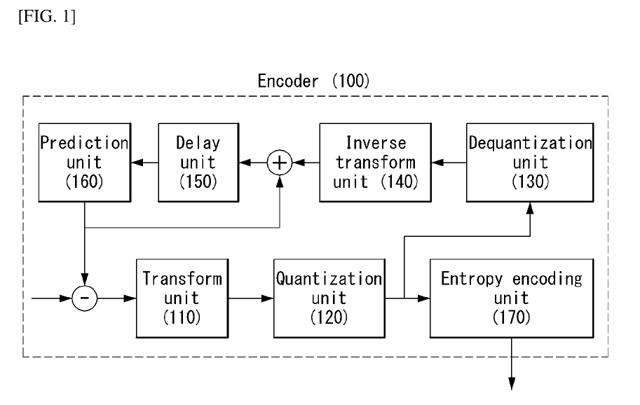

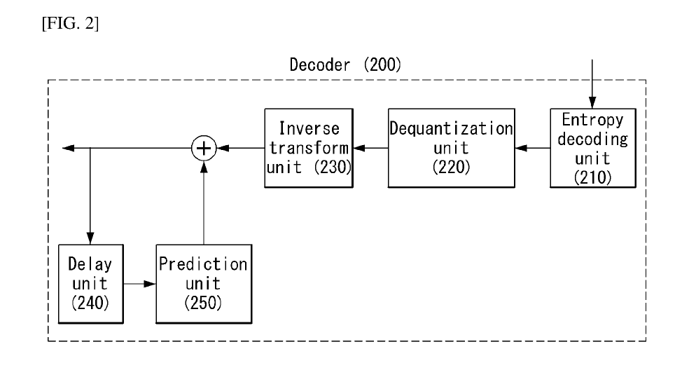

FIGS. 1 and 2 illustrate schematic block diagrams of an encoder and a decoder in which media coding is performed.

The encoder 100 of FIG. 1 includes a transform unit 110, a quantization unit 120, a dequantization unit 130, an inverse transform unit 140, a delay unit 150, a prediction unit 160, and an entropy encoding unit 170. The decoder 200 of FIG. 2 includes an entropy decoding unit 210, a dequantization unit 220, an inverse transform unit 230, a delay unit 240, and a prediction unit 250.

The encoder 100 receives the original video signal and generates a prediction error by subtracting a prediction signal, output by the prediction unit 160, from the original video signal. The generated prediction error is transmitted to the transform unit 110. The transform unit 110 generates a transform coefficient by applying a transform scheme to the prediction error.

The transform scheme may include, for example, a block-based transform method and an image-based transform method. The block-based transform method may include, for example, Discrete Cosine Transform (DCT) and Karhuhen-Loeve Transform. The DCT means that a signal on a spatial domain is decomposed into two-dimensional frequency components. A pattern having lower frequency components toward an upper left corner within a block and higher frequency components toward a lower right corner within the block is formed. For example, only one of 64 two-dimensional frequency components that is placed at the top left corner may be a Direct Current (DC) component and may have a frequency of 0. The remaining frequency components may be Alternate Current (AC) components and may include 63 frequency components from the lowest frequency component to higher frequency components. To perform the DCT includes calculating the size of each of base components (e.g., 64 basic pattern components) included in a block of the original video signal, the size of the base component is a discrete cosine transform coefficient.

Furthermore, the DCT is transform used for a simple expression into the original video signal components. The original video signal is fully reconstructed from frequency components upon inverse transform. That is, only a method of representing video is changed, and all the pieces of information included in the original video in addition to redundant information are preserved. If DCT is performed on the original video signal, DCT coefficients are crowded at a value close to 0 unlike in the amplitude distribution of the original video signal. Accordingly, a high compression effect can be obtained using the DCT coefficients.

The quantization unit 120 quantizes the generated transform coefficient and sends the quantized coefficient to the entropy encoding unit 170. The entropy encoding unit 170 performs entropy coding on the quantized signal and outputs an entropy-coded signal.

The quantized signal output by the quantization unit 120 may be used to generate a prediction signal. For example, the dequantization unit 130 and the inverse transform unit 140 within the loop of the encoder 100 may perform dequantization and inverse transform on the quantized signal so that the quantized signal is reconstructed into a prediction error. A reconstructed signal may be generated by adding the reconstructed prediction error to a prediction signal output by the prediction unit 160.

The delay unit 150 stores the reconstructed signal for the future reference of the prediction unit 160. The prediction unit 160 generates a prediction signal using a previously reconstructed signal stored in the delay unit 150.

The decoder 200 of FIG. 2 receives a signal output by the encoder 100 of FIG. 1. The entropy decoding unit 210 performs entropy decoding on the received signal. The dequantization unit 220 obtains a transform coefficient from the entropy-decoded signal based on information about a quantization step size. The inverse transform unit 230 obtains a prediction error by performing inverse transform on the transform coefficient. A reconstructed signal is generated by adding the obtained prediction error to a prediction signal output by the prediction unit 250.

The delay unit 240 stores the reconstructed signal for the future reference of the prediction unit 250. The prediction unit 250 generates a prediction signal using a previously reconstructed signal stored in the delay unit 240.

Predictive coding, transform coding, and hybrid coding may be applied to the encoder 100 of FIG. 1 and the decoder 200 of FIG. 2. A combination of all the advantages of predictive coding and transform coding is called hybrid coding.

Prediction coding may be applied to each of samples every time, and the strongest method for prediction is to have a cyclic structure. Such a cyclic structure is based on the fact that prediction is most performed when the closest pixel value is used. That is, the best prediction may be performed if a predictor is used to predict another value right after it is coded.

By the way, a problem when such an approach is used in hybrid coding is that prediction residuals need to be grouped prior to transform. In such a case, the prediction of the cyclic structure may lead to an increase of accumulated errors because a signal may not be precisely reconstructed.

In the existing hybrid coding, prediction and transform are separated in two orthogonal dimensions. For example, in the case of video coding, prediction is adopted in a time domain and transform is adopted in a spatial domain. Furthermore, in the existing hybrid coding, prediction is performed from only data within a previously coded block. This may obviate error propagation, but has a disadvantage in that it reduces performance because some data samples within a block and data having a smaller statistical correlation are forced to be used within a prediction process.

Accordingly, an embodiment of the present invention is intended to solve such problems by removing constraints on data that may be used in a prediction process and enabling a new hybrid coding form in which the advantages of predictive coding and transform coding are integrated.

Furthermore, the present invention is to improve compression efficiency by providing a conditionally nonlinear transform method by taking into consideration a correlation between pixels on the spatial domain.

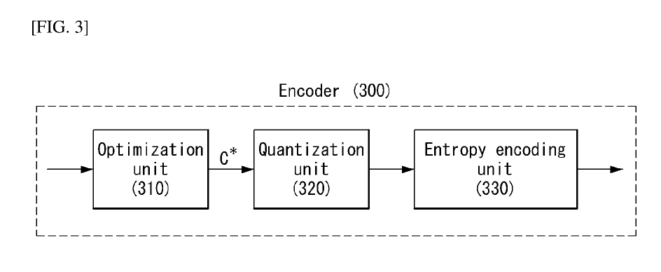

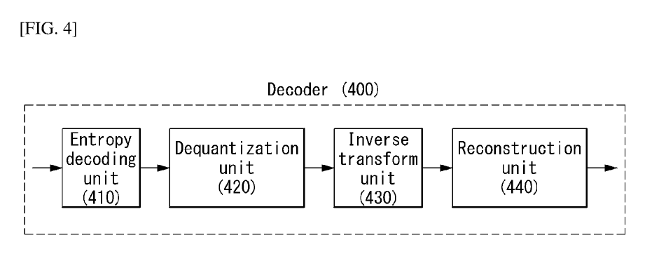

FIGS. 3 and 4 are embodiments to which the present invention may be applied and are schematic block diagrams illustrating an encoder and a decoder to which an advanced coding method may be applied.

In the existing codec, if transform coefficients for N data are to be obtained, N prediction data is extracted from the N original data at once, and transform coding is then applied to the obtained N residual data or a prediction error. In such a case, the prediction process and the transform process are sequentially performed.

However, if prediction is performed on video data including N pixels in a pixel unit using the most recently reconstructed data, the most accurate prediction results may be obtained. For this reason, to sequentially apply prediction and transform in an N-pixel unit may not be said to be an optimized coding method.

Meanwhile, in order to obtain the most recently reconstructed data in a pixel unit, residual data must be reconstructed by performing inverse transform on already obtained transform coefficients, and then the reconstructed residual data must be added to prediction data. However, in the existing coding method, it is impossible to reconstruct data in a pixel unit itself because transform coefficients can be obtained by applying transform only after prediction for N data is ended.

Accordingly, the present invention proposes a method of obtaining a transform coefficient using a previously reconstructed signal and a context signal.

The encoder 300 of FIG. 3 includes an optimization unit 310, a quantization unit 320, and an entropy encoding unit 330. The decoder 400 of FIG. 4 includes an entropy decoding unit 410, a dequantization unit 420, an inverse transform unit 430, and a reconstruction unit 440.

Referring to the encoder 300 of FIG. 3, the optimization unit 310 obtains an optimized transform coefficient. The optimization unit 310 may use the following embodiments in order to obtain the optimized transform coefficient.

In order to illustrate an embodiment to which the present invention may be applied, first, a reconstruction function for reconstructing a signal may be defined as follows.

\tilde{x}=R(c,y) [Equation 1]

In Equation 1, \tilde{x} denotes a reconstructed signal, c denotes a decoded transform coefficient, and y denotes a context signal. R(c,y) denotes a nonlinear reconstruction function using c and y in order to generate a reconstructed signal.

In one embodiment to which the present invention is applied, there is provided a method of generating an advanced non-linear predictor in order to obtain an optimized transform coefficient.

In the present embodiment, a prediction signal may be defined as a relation between previously reconstructed values and a transform coefficient. That is, the encoder and the decoder to which the present invention is applied may generate an optimized prediction signal by taking into consideration all of previously reconstructed signals when performing a prediction process. Furthermore, a non-linear prediction function may be applied as a prediction function for generating a prediction signal. Accordingly, each of decoded transform coefficients affects the entire reconstruction process and enables control of a prediction error included in a prediction error vector.

For example, the prediction error signal may be defined as follows.

e=Tc [Equation 2]

In this case, e indicates a prediction error signal, c indicates a decoded transform coefficient, and T indicates a transform matrix.

In this case, the reconstructed signal may be defined as follows.

$${\tilde{x}}_{1} = {R}_{1} ( {e}_{1} , y ) \\ {\tilde{x}}_{2} = {R}_{2} ( {e}_{2} , y , {\tilde{x}}_{1} ) \\ ⋮ \\ {\tilde{x}}_{n} = {R}_{n} ( {e}_{n} , y , {\tilde{x}}_{1} , {\tilde{x}}_{2} … , {\tilde{x}}_{n - 1} ) \qquad [ Equation 3 ]$$

In this case, \tilde{x}ₙ indicates an n-th reconstructed signal, eₙ indicates an n-th prediction error signal, y indicates a context signal, and Rₙ indicates a non-linear reconstruction function using eₙ and y in order to generate a reconstructed signal. [89] For example, the non-linear reconstruction function Rₙ may be defined as follows.

$${R}_{1} ( {e}_{1} , y ) = {P}_{1} ( y ) + {e}_{1} \\ {R}_{2} ( {e}_{2} , y , {\tilde{x}}_{1} ) = {P}_{2} ( y , {\tilde{x}}_{1} ) + {e}_{2} \\ ⋮ \\ {R}_{n} ( {e}_{n} , y , {\tilde{x}}_{1} , … , {\tilde{x}}_{n - 1} ) = {P}_{n} ( y , {\tilde{x}}_{1} , {\tilde{x}}_{2} … , {\tilde{x}}_{n - 1} ) + {e}_{n} \qquad [ Equation 4 ]$$

In this case, Pₙ indicates a non-linear prediction function including the variables in order to generate a prediction signal.

The non-linear prediction function may be a combination of linear functions in addition to a combination of a median function and a rank order filter and a non-linear function, for example. Furthermore, the non-linear prediction function Pₙ ( ) may be different non-linear functions.

In another embodiment, the encoder 300 and the decoder 400 to which the present invention is applied may include the storage of candidate functions for selecting the non-linear prediction function.

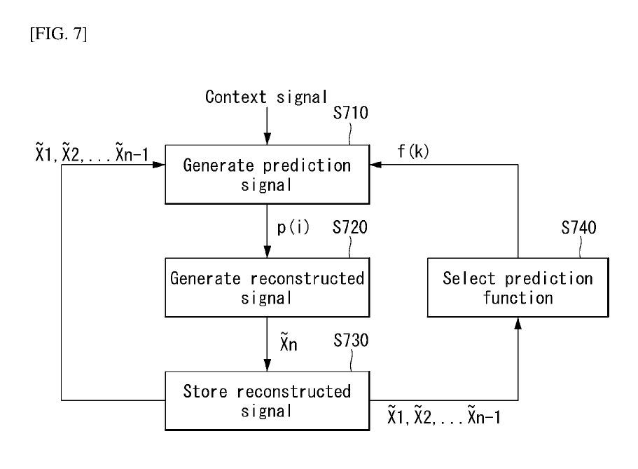

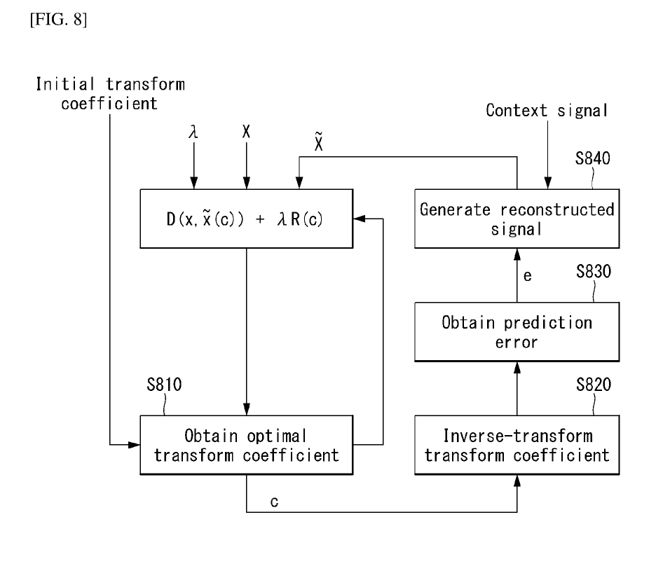

For example, the optimization unit 310 may select an optimized non-linear prediction function in order to generate an optimized transform coefficient. In this case, the optimized non-linear prediction function may be selected from the candidate functions stored in the storage. This is described in more detail in FIGS. 7 and 8.

The optimization unit 310 may generate an optimized transform coefficient by selecting the optimized non-linear prediction function as described above.

Meanwhile, the output transform coefficient is transmitted to the quantization unit 320. The quantization unit 320 quantizes the transform coefficient and sends the quantized transform coefficient to the entropy encoding unit 330.

The entropy encoding unit 330 may perform entropy encoding on the quantized transform coefficient and output a compressed bitstream.

The decoder 400 of FIG. 4 may receive the compressed bitstream from the encoder of FIG. 3, may perform entropy decoding through the entropy decoding unit 410, and may perform dequantization through the dequantization unit 420. In this case, a signal output by the dequantization unit 420 may mean an optimized transform coefficient.

The inverse transform unit 430 receives the optimized transform coefficient, performs an inverse transform process, and may generate a prediction error signal through the inverse transform process.

The reconstruction unit 440 may obtain a reconstructed signal by adding the prediction error signal and a prediction signal together. In this case, various embodiments described with reference to FIG. 3 may be applied to the prediction signal.

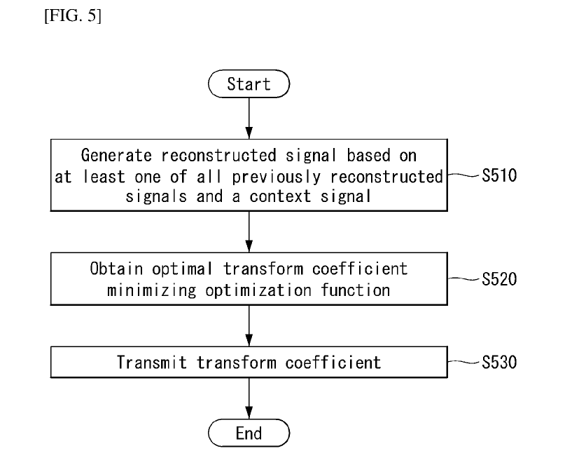

FIG. 5 is an embodiment to which the present invention may be applied and is a schematic flowchart illustrating an advanced video coding method.

The encoder may generate a reconstructed signal based on at least one of all of previously reconstructed signals and context signals (S510). In this case, the context signal may include at least one of a previously reconstructed signal, a previously reconstructed intra-coded signal, and another piece of information related to the decoding of a previously reconstructed portion or signal to be reconstructed, of a current frame. The reconstructed signal may be the sum of a prediction signal and a prediction error signal. Each of the prediction signal and the prediction error signal may be generated based on at least one of a previously reconstructed signal and a context signal.

The encoder may obtain an optimized transform coefficient that minimizes an optimization function (S520). In this case, the optimization function may include a distortion component, a rate component and a Lagrange multiplier A. The distortion component may have a difference between the original video signal and a reconstructed signal, and the rate component may include a previously obtained transform coefficient. A indicates a real number that maintains the balance of a distortion component and a rate component.

The obtained transform coefficient experiences quantization and entropy encoding and is then transmitted to the decoder (S530).

Meanwhile, the decoder receives the transmitted transform coefficient and obtains a prediction error vector through entropy decoding, dequantization and inverse transform processes. The prediction unit of the decoder generates a prediction signal using all of samples that have already been reconstructed and available, and may reconstruct a video signal based on the prediction signal and the reconstructed prediction error vector. In this case, the embodiments described in the encoder may be applied to the process of generating the prediction signal.

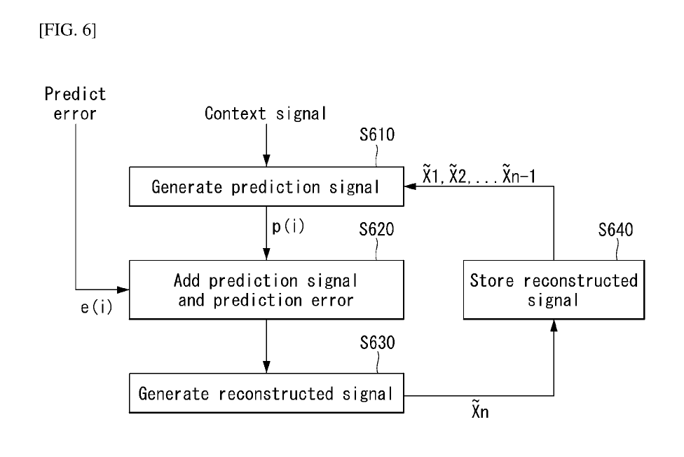

FIG. 6 is an embodiment to which the present invention may be applied and is a flowchart illustrating a video coding method for using a previously reconstructed signal and a context signal to generate an optimized transform coefficient.

In the present embodiment, a prediction signal may be generated using previously reconstructed signals \tilde{x}₁, \tilde{x}₂, . . . , \tilde{x}ₙ₋₁ and a context signal at step S610.

For example, the previously reconstructed signals may mean \tilde{x}₁, \tilde{x}₂, . . . , \tilde{x}ₙ₋₁ defined in Equation 3. Furthermore, a non-linear prediction function may be used to generate the prediction signal, and a different non-linear prediction function may be adaptively applied to each of prediction signals.

The prediction signal is added to a received prediction error signal e(i) at step S620, thus generating a reconstructed signal at step S630. Step S620 may be performed by an adder (not illustrated).

The generated reconstructed signal \tilde{x}ₙ may be stored for future reference at step S640. The stored signal may be used to generate a next prediction signal.

By removing constraints on data that may be used in a process of generating a prediction signal as described above, that is, by generating a prediction signal using all the signals that have already been reconstructed, more advanced compression efficiency can be provided.

A process of generating a prediction signal at step S610 is described in more detail below.

FIG. 7 is an embodiment to which the present invention may be applied and is a flowchart illustrating a process of generating a prediction signal used to generate an optimal transform coefficient.

As described above with reference to FIG. 6, in accordance with an embodiment of the present invention, a prediction signal p(i) may be generated using previously reconstructed signals \tilde{x}₁, \tilde{x}₂, . . . , \tilde{x}ₙ₋₁ and a context signal at step S710. In this case, in order to generate the prediction signal, an optimized prediction function f(k) may need to be selected.

The reconstructed signal \tilde{x}ₙ may be generated using the prediction signal at step S720. The reconstructed signal \tilde{x}ₙ may be stored for future reference at step S730.

Accordingly, in order to select the optimized prediction function, all the signals \tilde{x}₁, \tilde{x}₂, . . . , \tilde{x}ₙ₋₁ that have already been reconstructed and a context signal may be used. For example, in accordance with an embodiment of the present invention, a candidate function that minimizes the sum of a distortion measurement value and a rate measurement value may be searched for, and the optimized prediction function may be selected at step S740.

In this case, the distortion measurement value includes a measurement value of distortion between the original video signal and the reconstructed signal. The rate measurement value includes a measurement value of a rate that is required to send or store a transform coefficient.

More specifically, in accordance with an embodiment of the present invention, the optimized prediction function may be obtained by selecting a candidate function that minimizes Equation 5 below.

$${c}^{*} = {argmin}_{{c}_{1} ∈ {Ω}_{1} , … , {c}_{n} ∈ {Ω}_{n}} \{ D ( x , \tilde{x} ( c ) ) + λ R ( c ) \} \qquad [ Equation 5 ]$$

In Equation 5, c* denotes a “c” value that minimizes Equation 5, that is, a decoded transform coefficient. Furthermore, D(x,\tilde{x}(c)) denotes a measurement value of distortion between the original video signal and a reconstructed signal thereof, and R(c) denotes a measurement value of the rate that is required to send or store a transform coefficient “c”.

For example, D(x,\tilde{x}(c)) may be ll x-\tilde{x}(c)ll_{q} (q=0, 0.1, 1, 1.2, 2, 2.74, 7, etc.). R(c) may be indicative of the number of bits that is used to store a transform coefficient “c” using an entropy coder, such as a Huffman coder or an arithmetic coder. Alternatively, R(c) may be indicative of the number of bits that is predicted according to an analytical rate model, such as a Laplacian or Gaussian probability model, R(c)=ll x-\tilde{x}(c)llτ (τ=0, 0.4, 1, 2, 2.2, etc.)

Meanwhile, λ denotes a Lagrange multiplier used for the optimization of the encoder. For example, λ may be indicative of a real number that keeps the balance between a measurement value of distortion and a measurement value of the rate.

FIG. 8 is an embodiment to which the present invention may be applied and is a flowchart illustrating a method of obtaining an optimized transform coefficient.

The present invention may provide an advanced coding method by obtaining an optimized transform coefficient that minimizes the sum of a distortion measuring value and a rate measuring value.

First, the encoder may obtain an optimized transform coefficient that minimizes the sum of a distortion measuring value and a rate measuring value (S810). For example, Equation 5 may be applied to the sum of the distortion measuring value and the rate measuring value. In this case, at least one of the original video signal x, a previously reconstructed signal \tilde{x}, a previously obtained transform coefficient and a Lagrange multiplier λ may be used as an input signal. In this case, the previously reconstructed signal may have been obtained based on the previously obtained transform coefficient.

The optimized transform coefficient c is inverse-transformed through an inverse transform process (S820), thereby obtaining a prediction error signal (S830).

The encoder generates the reconstructed signal \tilde{x} using the obtained error signal (S840). In this case, a context signal may be used to generate the reconstructed signal \tilde{x}.

The generated reconstructed signal may be used to obtain an optimized transform coefficient that minimizes the sum of a distortion measuring value and a rate measuring value.

As described above, an optimized transform coefficient is updated and may be used to obtain a new optimized transform coefficient through a reconstruction process.

Such a process may be performed by the optimization unit 310 of the encoder 300. The optimization unit 310 outputs a newly obtained transform coefficient, and the outputted transform coefficient is compressed through quantization and entropy encoding processes and transmitted.

In one embodiment of the present invention, a prediction signal is used to obtain an optimized transform coefficient, and the prediction signal may be defined by a relation between previously reconstructed signals and the transform coefficient. In this case, the transform coefficient may be described by Equation 2. As in Equation 2 and Equation 3, each transform coefficient may influence the entire reconstruction process and may enable wide control of a prediction error included in a prediction error vector.

In an embodiment of the present invention, the reconstruction process may be constrained to be linear. In such a case, the reconstructed signal may be defined as in Equation 6 below.

\tilde{x}=FTc+Hy [Equation 6]

In Equation 6, x denotes a reconstructed signal, c denotes a decoded transform coefficient, and y denotes a context signal. Furthermore, F, T,H denotes a nxn matrix.

In an embodiment of the present invention, a nxn matrix S may be used to control quantization errors included in a transform coefficient. In such a case, the reconstructed signal may be defined as follows.

\tilde{x}=FSTc+Hy [Equation 7]

The matrix S for controlling quantization errors may be obtained using a minimization process of Equation 8.

$${min}_{S} \{ {\sum }_{x ∈ T}^{ } {min}_{{c}_{1} ∈ {Ω}_{1} , … , {c}_{n} ∈ {Ω}_{n}} \{ D ( x , \tilde{x} ( c ) ) + λ R ( c ) \} \} \qquad [ Equation 8 ]$$

In Equation 8, T denotes a training signal, and a transform coefficient “c” is aligned in an n-dimension vector. Transform coefficient components satisfy Cᵢ ∈Ωᵢ. In this case, Ωᵢ is indicative of a set of discrete values. In general, Ωᵢ is determined through a dequantization process to which an integer value has been applied. For example, Ωᵢ may be {−3Δi, −2Δi, −1Δi, 0Δi, 2Δi, 3Δi, . . . }. In this case, Δi is indicative of a uniform quantization step size. Furthermore, each of the transform coefficients may have a different quantization step size.

In an embodiment of the present invention, the nxn matrix F, S,H in Equation 7 may be optimized in common with respect to a training signal. The common optimization method may be performed by minimizing Equation 9.

$${Min}_{F , H} {\sum }_{λ ∈}^{ } \{ {min}_{{S}_{λ}} \{ {\sum }_{x ∈ T}^{ } {min}_{{c}_{1} ∈ {Ω}_{1} , … , {c}_{n} ∈ {Ω}_{n}} \{ D ( x , \tilde{x} ( c ) ) + λ R ( c ) \} \} \} \} \qquad [ Equation 9 ]$$

In Equation 9, Λ={λ₁, λ₂, . . . , λ_{L}} denotes a target set of constraint multipliers, and L is an integer. Furthermore, a reconstruction function in λ may be formed as follows.

\tilde{x}_{λ}=FS_{λ}Tc+Hy. [Equation 10]

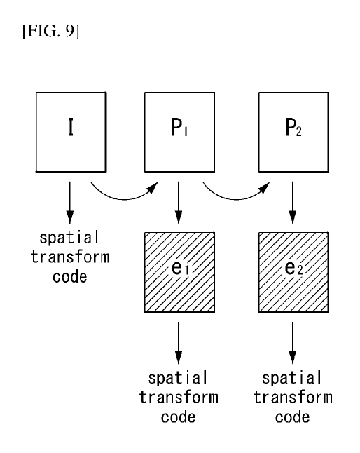

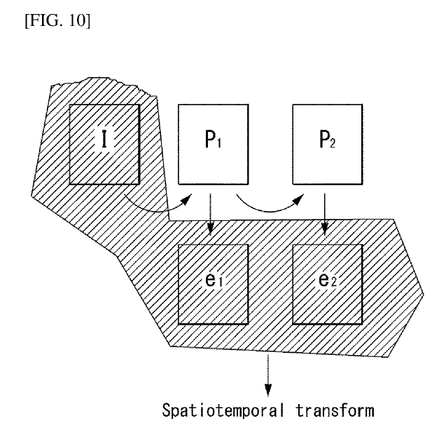

FIGS. 9 and 10 are embodiments to which the present invention may be applied and are conceptual diagrams illustrating a method of applying spatiotemporal transform to a group of pictures (GOP).

In accordance with an embodiment of the present invention, spatiotemporal transform may be applied to a GOP including V frames. In such a case, a prediction error signal and a reconstructed signal may be defined as follows.

$$\begin{matrix} e = {T}_{st} c & [ Equation 11 ] \\ {R}_{1} ( {e}_{1} , y ) = {P}_{1} ( y ) + {e}_{1} \\ {R}_{2} ( {e}_{2} , y , {\tilde{x}}_{1} ) = {P}_{2} ( y , {\tilde{x}}_{1} ) + {e}_{2} \\ ⋮ \\ {R}_{n} ( {e}_{n} , y , {\tilde{x}}_{1} , … , {\tilde{x}}_{n - 1} ) = {P}_{n} ( y , {\tilde{x}}_{1} , {\tilde{x}}_{2} … , {\tilde{x}}_{n - 1} ) + {e}_{n} & [ Equation 12 ]\end{matrix}$$

In Equation 11, Tₛₜ denotes a spatiotemporal transform matrix, and c includes the decoded transform coefficient of all the GOPs.

In Equation 12, eᵢ denotes an error vector formed of error values corresponding to a frame. For example, in the case of an error of a GOP including V frames,

$$e = [ \begin{matrix}{e}^{1} \\ ⋮ \\ {e}^{V}\end{matrix} ]$$

may be defined. In this case, the error vector e may include all the error values of all the GOPs including the V frames.

Furthermore, \tilde{x}ₙ denotes an n^{th} reconstructed signal, and y denotes a context signal. Rₙ denotes a non-linear reconstruction function using eₙ and y in order to generate a reconstructed signal, and Pₙ denotes a non-linear prediction function for generating a prediction signal.

FIG. 9 is a diagram illustrating a known transform method in a spatial domain, and FIG. 10 is a diagram illustrating a method of applying spatiotemporal transform to a GOP.

From FIG. 9, it may be seen that in the existing coding method, transform code in the spatial domain has been independently generated with respect to each of the error values of I frame and P frame.

In contrast, in the case of FIG. 10 to which the present invention may be applied, coding efficiency can be further improved by applying joint spatiotemporal transform to the error values of I frame and P frame. That is, as can be seen from Equation 12, a video of high quality including a non-smooth or non-stationary signal can be coded more efficiently because a joint spatiotemporal-transformed error vector is used as a cyclic structure when a signal is reconstructed.

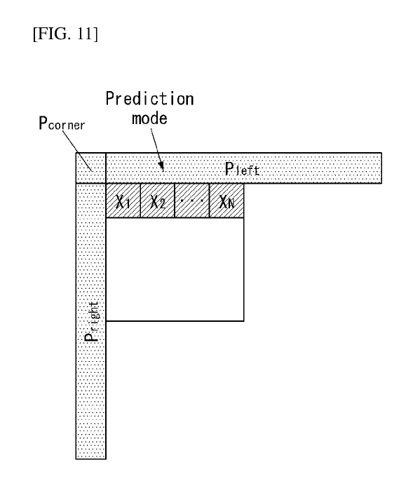

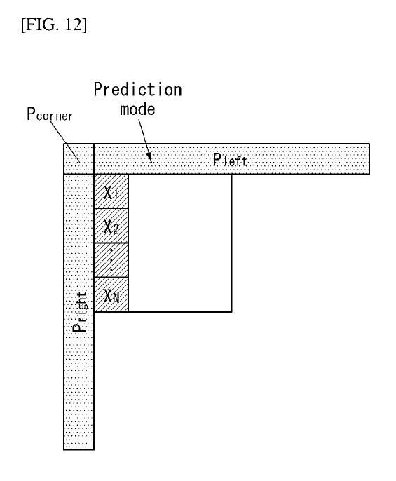

FIGS. 11 and 12 are embodiments to which the present invention is applied and are diagrams for illustrating a method of generating the prediction signal of the first line (row, column) of a current block using neighboring pixels.

An embodiment of the present invention provides a method of performing prediction using the most recently reconstructed data in a pixel unit with respect to video data consisting of N pixels.

If a transform coefficient for N data is calculated, N prediction data is extracted from N original data at once, and transform coding is then applied to the obtained N residual data. Accordingly, a prediction process and a transform processes are sequentially performed. However, if prediction for video data including N pixels is performed in a pixel unit using the most recently reconstructed data, the most accurate prediction results may be obtained. Accordingly, to sequentially apply prediction and transform in an N-pixel unit may not be said to be an optimized coding method.

In order to obtain the most recently reconstructed data in a pixel unit, after inverse transform is performed using already calculated transform coefficients, residual data must be reconstructed and then added to prediction data. However, in the existing coding method, it is impossible to reconstruct data in a pixel unit because transform coefficients can be obtained by applying transform only after prediction for N data is ended.

However, if a prediction process for (x, N×1 vector) with respect to the original data may be expressed as a relation equation between reference data x₀ and an N×1 residual vector \hat{r} as in Equation 13, transform coefficients may be calculated at once from Equation 14 and Equation 15.

x=F\hat{r}+Bx₀ [Equation 13]

x=FTĉ+Bx₀ [Equation 14]

x_{R}=x−Bx₀=Gĉ, ĉ=G⁻¹x_{R} [Equation 15]

That is, this may be said to be a method of using transform coefficients not available in the prediction process as an unknown quantity f and inversely obtaining f through the equation. A prediction process using the most recently reconstructed pixel data may be described through the F matrix of Equation 13, and this is the same as that described above. Furthermore, in the aforementioned embodiments, the transform coefficients may not be calculated by multiplying the G⁻¹ matrix as in Equation 15, but the method of performing up to quantization at once through the iterative optimized algorithm has been described above.

However, in general, in order to apply the method to an N×N original image block, a process of transforming the corresponding original image block into a x vector of N²×1 is necessary and a G matrix of N²×N² may be necessary for each prediction mode. Accordingly, the present invention proposes a method of applying the CNT algorithm using only N×N transform by restricting a prediction direction.

In the previous conditionally nonlinear transform (CNT) embodiment, after the N²×N² non-orthogonal transform is configured for each prediction mode with respect to the N×N block, the transform coefficients have been calculated by applying corresponding non-orthogonal transform to the N²×1 vector aligned from the N×N block through row ordering or column ordering. However, such embodiments have the following disadvantages.

1) Since N²×N² transform is required, a computational load is increased and a large memory space for storing transform coefficients is necessary if N increases. Accordingly, scalability for N is reduced.

2) Corresponding N²×N² non-orthogonal transform is necessary for each prediction mode. Accordingly, a large memory storage space may be necessary to store transform coefficients for all of prediction modes.

A practical limit may be applied to the size of a block to which the CNT may be applied due to the problems. Accordingly, the present invention proposes the following improved embodiments.

First, one embodiment of the present invention provides a method of restricting the direction in which a reconstructed pixel is referred with respect to all of pixel positions to any one of horizontal and vertical directions.

For example, a N×N transform matrix instead of an N²×N² transform matrix may be applied to a N×N block. The N×N transform matrix is sequentially applied to the rows and columns of the N×N block. Accordingly, the CNT of the present invention is named a separable CNT.

Second, one embodiment of the present invention provides a method of predicting only the first line (row, column) of a current block by taking into consideration a prediction mode and using a reconstructed pixel neighboring in the horizontal or vertical direction with respect to the remaining pixels.

A neighboring reconstructed pixel to which reference is made is a value reconstructed based on residual data to which the present invention has already been applied. Accordingly, a pixel that refers to the reconstructed pixel at the current position has a very low association with an applied prediction mode (e.g. an intra-prediction angular mode). Accordingly, the precision of prediction can be improved through such a method.

In intra-prediction, prediction is performed on a current block based on a prediction mode. A reference sample used for prediction and a detailed prediction method are different depending on the prediction mode. If a current block has been encoded according to the intra-prediction mode, the decoder may obtain the prediction mode of the current block in order to perform a prediction.

The decoder may check whether neighboring samples of the current block may be used for prediction and configure reference samples to be used for prediction.

For example, referring to FIG. 11, neighboring samples of a current block may mean at least one of a sample neighboring to the left boundary and a total of 2N samples P_{left} neighboring to the bottom left of the current block of a N×N size, a sample neighboring to the top boundary block and a total of 2N samples Pᵤₚₚₑᵣ neighboring to the top right of the current block, and one sample P_{corner} neighboring to the top left corner of the current block. In this case, assuming that reference pixels used to generate a prediction signal is Pb, Pb may include the 2N samples P_{left} on the left, the 2N samples Pᵤₚₚₑᵣ at the top and the sample P_{corner} at the top left corner.

Meanwhile, some of neighboring samples of a current block have not yet been decoded or may not be available. In this case, the decoder may configure reference samples to be used for prediction by substituting unavailable samples with available samples.

As in FIGS. 11 and 12, a predictor for the first line (row, column) of a current block may be calculated using neighboring pixels P_{b} of a N×N current block. In this case, the predictor may be expressed as the function of the neighboring pixels P_{b} and a prediction mode as in Equation 16.

$$[ \begin{matrix}{X}_{1} \\ {X}_{2} \\ ⋮ \\ {X}_{N}\end{matrix} ] = f ( {P}_{b} , mode ) \qquad [ Equation 16 ]$$

In this case, the mode indicates an intra-prediction mode, and the function f( ) indicates a method of performing intra-prediction.

A predictor for the first line (row, column) of a current block can be obtained through Equation 16.

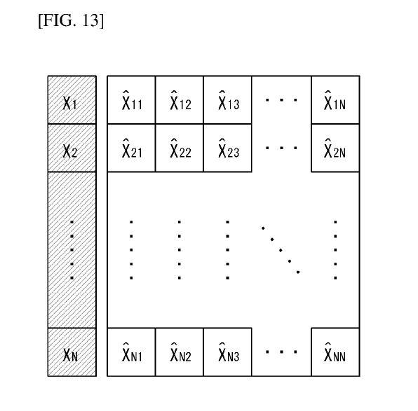

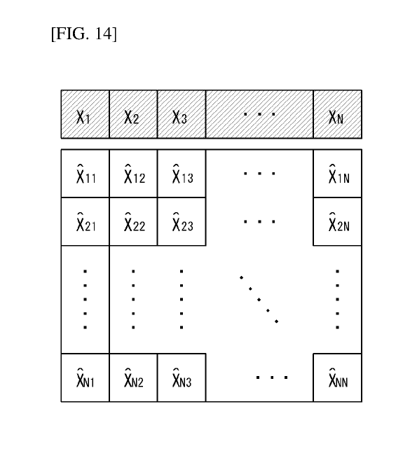

FIGS. 13 and 14 are embodiments to which the present invention is applied and are diagrams for illustrating a method of reconstructing a current block based on the prediction signal of the first line (row, column) of a current block.

When a predictor for the first line of a current block is determined through Equation 16, the pixels of a N×N current block may be reconstructed using the predictor for the first line of the current block. In this case, the reconstructed pixels of the current block may be determined based on Equation 17 and Equation 18 below. Equation 17 shows that the pixels of the N×N current block are reconstructed in a horizontal direction (the right direction or the horizontal direction) using a predictor for the first column of the current block. Equation 18 shows that the pixels of the N×N current block are reconstructed in a vertical direction using a predictor for the first row of the current block.

$$\begin{matrix}{\hat{x}}_{i 1} = {x}_{i} + {\hat{r}}_{i 1} \\ {\hat{x}}_{i 2} = {x}_{i} + {\hat{r}}_{i 1} + {\hat{r}}_{i 2} \\ ⋮ \\ {\hat{x}}_{iN} = {x}_{i} + {\hat{r}}_{i 1} + {\hat{r}}_{i 2} + … + {\hat{r}}_{iN} , i = 1 , 2 , … , N & [ Equation 17 ] \\ {\hat{x}}_{1 j} = {x}_{j} + {\hat{r}}_{1 j} \\ {\hat{x}}_{2 j} = {x}_{j} + {\hat{r}}_{1 j} + {\hat{r}}_{2 j} \\ ⋮ \\ {\hat{x}}_{Nj} = {x}_{j} + {\hat{r}}_{1 j} + {\hat{r}}_{2 j} + … + {\hat{r}}_{Nj} , j = 1 , 2 , … , N & [ Equation 18 ]\end{matrix}$$

Equation 17 and Equation 18 determine a reconstructed pixel value at each position within the block.

In Equation 17 and Equation 18, \hat{x}ᵢⱼ means pixel values reconstructed based on residual data \hat{r}ᵢⱼ and may be different from those of the original data. However, assuming that \hat{r}ᵢⱼ may be determined to be the same as the original data, \hat{x}ᵢⱼ may be assumed to be the same as the original data at the current point of time.

As in FIG. 13 and Equation 17, if the pixel values of a current block are predicted in the horizontal direction (the right direction or the horizontal direction) based on a predictor for the first column of the current block, Equation 19 may be derived.

X=\hat{X}=\hat{R}F+X₀B=T_{C}^{T}ĈT_{R}F+X₀B [Equation 19]

In this case, in Equation 19, X=\hat{X} has been set, assuming that \hat{R} may be determined so that the future reconstructed data becomes the same as the original data. X indicates the original N×N image block, \hat{R} indicates residual data, and X₀ indicates reference data.

The notations of Equation 19 may be expressed as in Equation 20 to Equation 23.

$$\begin{matrix}\hat{R} = [ \begin{matrix}{\hat{r}}_{11} & {\hat{r}}_{12} & … & {\hat{r}}_{1 N} \\ {\hat{r}}_{21} & {\hat{r}}_{22} & … & {\hat{r}}_{2 N} \\ … & … & … & … \\ {\hat{r}}_{N 1} & {\hat{r}}_{N 2} & … & {\hat{r}}_{NN}\end{matrix} ] & [ Equation 20 ] \\ F = [ \begin{matrix}1 & 1 & 1 & 1 & … & 1 \\ 0 & 1 & 1 & 1 & … & 1 \\ 0 & 0 & 1 & 1 & … & 1 \\ 0 & 0 & 0 & 1 & … & 1 \\ … & … & … & … & … & 1 \\ 0 & 0 & 0 & 0 & … & 1\end{matrix} ] & [ Equation 21 ] \\ {X}_{0} = [ \begin{matrix}{X}_{1} & 0 & … & 0 \\ 0 & {X}_{2} & … & 0 \\ … & … & … & 0 \\ 0 & 0 & … & {X}_{N}\end{matrix} ] & [ Equation 22 ] \\ B = [ \begin{matrix}1 & 1 & … & 1 \\ 1 & 1 & … & 1 \\ … & … & … & … \\ 1 & 1 & … & 1\end{matrix} ] & [ Equation 23 ]\end{matrix}$$

In Equation 19, T_{C} means transform (e.g., 1-D DCT/DST) in the column direction, and T_{R} means transform in the row direction. A residual matrix \hat{R} may be expressed as in Equation 24 because it may be obtained by applying inverse transform to Ĉ, that is, a dequantized transform coefficient matrix.

X_{R}=X−X₀B=\hat{X}−X₀B=T_{C}^{T}ĈT_{R}F [Equation 24]

In this case, if all of T_{C}, T_{R} and F are invertible matrices, Ĉ may be calculated by Equation 25 below. Furthermore, both F of Equation 19 and common orthogonal transform are invertible.

Ĉ=T_{C}^{-T}X_{R}F⁻¹T_{R}⁻¹ [Equation 25]

In this case, if T_{C} and T_{R} correspond to orthogonal transform, Equation 25 may be simplified as in Equation 26.

Ĉ=T_{C}X_{R}F⁻¹T_{R}^{T} [Equation 26]

In this case, F⁻¹T_{R}^{T} may be a predetermined value. For example, since F⁻¹T_{R}^{T} may have been previously calculated, Ĉ may be calculated through one matrix calculation with respect to the row direction and column direction along with transform, such as DCT.

For another example, after X_{R}F⁻¹ is first calculated, T_{R} and T_{C} may be applied. In this case, in the case of the F matrix in Equation 19, F⁻¹ may be determined as in Equation 27.

$${F}^{- 1} = [ \begin{matrix}1 & - 1 & 0 & … & 0 & 0 \\ 0 & 1 & - 1 & … & 0 & 0 \\ 0 & 0 & 1 & … & 0 & 0 \\ ⋮ & ⋮ & ⋮ & ⋱ & ⋮ & ⋮ \\ 0 & 0 & 0 & … & 1 & - 1 \\ 0 & 0 & 0 & … & 0 & 1\end{matrix} ] \qquad [ Equation 27 ]$$

As in Equation 27, since X_{R}F⁻¹ may be calculated by subtraction operation, ((N-1)×N-times subtractions) multiplying operation is unnecessary. Since transform, such as DCT or DST, may be used as T_{R} and T_{C} without any change, a computational load is not increased compared to the existing codec from a viewpoint of the multiplication amount.

Furthermore, the range of each of component values forming X_{R}F⁻¹ becomes the same as the range in the existing codec, and thus the quantization method in the existing codec may be applied without any change. In this case, the reason why the range is not changed is as follows.

One component (an i-th row, a j-th column) of X_{R}F⁻¹ may be expressed using 9-bit data because it can be calculated by the F⁻¹ matrix of Equation 27 as in Equation 28.

(X_{R})_{i,j}−(X_{R})_{i,j-1}=[(X)_{i,j}−xᵢ]−[(X)_{i,j-1}−xᵢ]=(X)_{i,j}−(X)_{i,j-1}=9 bit [Equation 28]

Accordingly, the input to T_{R} and T_{C} is the same as a transform input range in the existing codec because it is determined to be the 9-bit data.

Meanwhile, Ĉ obtained through Equation 25 and Equation 26 may basically have a real number value because it is a value that results in X=\hat{X}. However, data transmitted as a bitstream through a coding process is a quantized value. If dequantization is performed after quantization coefficients are calculated, a result C̆ slightly different from the original Ĉ is obtained.

Accordingly, in order to calculate Ĉ without a loss of data through Equation 25 and Equation 26, a quantized transform coefficient needs to be calculated. Each of elements forming Ĉ may not be a multiple of a quantization step size. In this case, after each element is divided by the quantization step size, a rounding operation may be applied or the quantized transform coefficient may be calculated through the iterative quantization process. In a subsequent step, additional rate distortion (RD) optimization may be performed by applying an encoding scheme, such as rate-distortion optimized quantization (RDOQ).

In the process of calculating the quantized transform coefficients, in the present invention, a C̆ matrix that minimizes a square error value in Equation 29 below can be found. Each of the elements of C̆ is a multiple of a quantization step size and may be obtained using the iterative quantization method.

E=∥X_{R}−T_{C}^{T}C̆T_{R}F∥² [Equation 29]

In this case, a norm value may be obtained by calculating the sum of a square for each element of the matrix and then taking a square root. In this case, if T_{C} is an orthogonal matrix, Equation 29 may be simplified like Equation 30.

E=∥X_{R}−T_{C}^{T}C̆T_{R}F∥²=∥T_{C}X_{R}−C̆T_{R}F∥²=∥X_{R}^{T}T_{C}^{T}−F^{T}T_{R}^{T}C̆^{T}∥²=∥\tilde{X}_{R}−GC̆^{T}∥² [Equation 30]

In this case, C̆^{T} may be calculated by solving the least square equation or may be calculated through the iterative quantization method. The value of the least square equation may be an initial value of an iterative procedure. Furthermore, a previously calculated value may be used without calculating the G matrix of Equation 30 every time.

If a vertical direction (a longitudinal or a downward direction) is predicted based on the pixels of the first row of a current block as in FIG. 14 and Equation 18, a relation equation, such as Equation 31 below, may be derived in a form similar to Equation 19.

$$\hat{X} = F \hat{R} + {BX}_{0} , F = [ \begin{matrix}1 & 0 & 0 & 0 & … & 0 \\ 1 & 1 & 0 & 0 & … & 0 \\ 1 & 1 & 1 & 0 & … & 0 \\ 1 & 1 & 1 & 1 & … & 0 \\ ⋮ & ⋮ & ⋮ & ⋮ & ⋱ & ⋮ \\ 1 & 1 & 1 & 1 & … & 1\end{matrix} ] \qquad [ Equation 31 ]$$

In this case, \hat{R}, B and X₀ matrices are the same as in Equation 19. If the equations are arranged using the same method as that in Equation 24 and Equation 25, it results in Equations 32 to 34. In this case, X=\hat{X} may be assumed.

X=\hat{X}=F\hat{R}+BX₀=FT_{C}^{T}ĈT_{R}+BX₀ [Equation 32]

X_{R}=X−BX₀=\hat{X}−BX₀=FT_{C}^{T}ĈT_{R} [Equation 33]

\hat{C}=(FT_{C}^{T})⁻¹X_{R}T_{R}⁻¹ [Equation 34]

In this case, if T_{C} and T_{R} are orthogonal transform, Ĉ may be determined as in Equation 35.

Ĉ=T_{C}F⁻¹X_{R}T_{R}^{T} [Equation 35]

In this case, the same method as the aforementioned method may be applied to a process of calculating quantized transform coefficients from Ĉ. For example, as in FIG. 13 and Equation 17, there may be a case where prediction is performed in the horizontal direction using the first row of current block pixels (pixels on the far left). In this case, T_{C}F⁻¹ may be a predetermined value. For example, the T_{C}F⁻¹ may have been previously calculated because it is a fixed value. Alternatively, after F⁻¹X_{R} is calculated, T_{R} and T_{C} may be sequentially applied. The F⁻¹ matrix for the F matrix in Equation 31 may be calculated as in Equation 36 below.

$${F}^{- 1} = [ \begin{matrix}1 & 0 & 0 & … & 0 & 0 \\ - 1 & 1 & 0 & … & 0 & 0 \\ 0 & - 1 & 1 & … & 0 & 0 \\ ⋮ & ⋮ & ⋮ & ⋱ & ⋮ & ⋮ \\ 0 & 0 & 0 & … & 1 & 0 \\ 0 & 0 & 0 & … & - 1 & 1\end{matrix} ] \qquad [ Equation 36 ]$$

Accordingly, since multiplication is unnecessary when F⁻¹X_{R} is calculated, a computational load is not increased from a viewpoint of the multiplication amount.

Furthermore, the same quantization method as that of the existing codec may be applied because the range of each element value of F⁻¹X_{R} is not changed.

Decoding may be performed using a process of calculating X_{R} by substituting C̆, that is, a dequantized transform coefficient matrix, instead of Ĉ in Equation 35 and then reconstructing \hat{X} by adding BX₀. This may be expressed as in Equation 37 below. This may be applied to Equation 26 in the same manner.

X_{R}=FT_{C}^{T}C̆T_{R}

\hat{X}=X_{R}+BX₀ [Equation 37]

That is, referring to Equation 37, in the present invention, after C̆, that is, the dequantized transform coefficient matrix, is sequentially inverse-transformed with respect to the column direction and the row direction, the substantial residual signal X_{R} may be configured by multiplying the F matrix. If the prediction signal BX₀ is added to X_{R}, the reconstructed signal \hat{X} can be obtained.

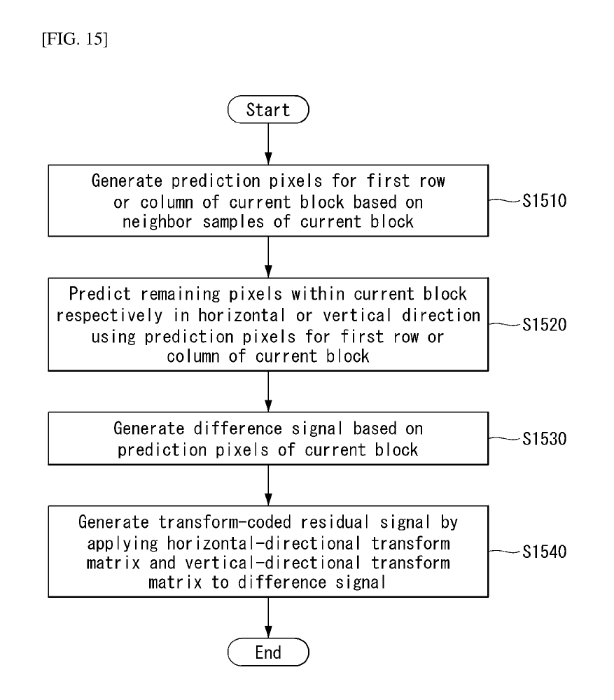

FIG. 15 is an embodiment to which the present invention is applied and is a flowchart for illustrating a method of encoding a current block using separable conditionally non-linear transform (SCNT).

The present invention provides a method of sequentially applying N×N transform to the rows and columns of a N×N block.

Furthermore, the present invention provides a method of performing prediction by taking into consideration a prediction mode with respect to only the first line (row or column) of a current block and performing prediction using previously reconstructed pixels neighboring in a vertical direction or a horizontal direction with respect to the remaining pixels.

First, the encoder may generate prediction pixels for the first row or column of a current block based on neighboring samples of the current block (S1510).

In this case, the neighboring samples of the current block may indicate boundary pixels neighboring to the current block. For example, as in FIG. 11, when the current block has a N×N size , the boundary pixels neighboring to a current block may mean at least one of a sample neighboring to the left boundary and a total of 2N samples P_{left} neighboring to the bottom left of the current block, a sample neighboring to the top boundary block and a total of 2N samples Pᵤₚₚₑᵣ neighboring to the top right of the current block, and one sample P_{corner} neighboring to the top left corner of the current block. In this case, assuming that reference pixels used to generate a prediction signal is Pb, Pb may include the 2N samples P_{left} on the left, the 2N samples Pᵤₚₚₑᵣ at the top and the sample P_{corner} at the top left corner.

Meanwhile, some of neighboring samples of a current block have not yet been decoded or may not be available. In this case, the encoder may configure reference samples to be used for prediction by substituting unavailable samples with available samples.

In one embodiment of the present invention, the prediction pixels for the first row or column of the current block may be obtained based on a prediction mode. In this case, the prediction mode indicates an intra-prediction mode, and the encoder may determine the prediction mode through coding simulations. For example, if the intra-prediction mode is a vertical mode, the prediction pixels for the first row of the current block may be obtained using neighboring pixels at the top.

The encoder may perform a prediction in a vertical direction or horizontal direction respectively with respect to the remaining pixels within the current block using the prediction pixels for the first row or column of the current block (S1520).

For example, if prediction pixels for the first row of the current block have been obtained, the prediction for the remaining pixels may be performed based on a previously reconstructed pixel in the vertical direction. Alternatively, if prediction pixels for the first column of the current block have been obtained, the prediction for the remaining pixels may be performed based on a previously reconstructed pixel in the horizontal direction.

In other embodiments of the present invention, prediction pixels for at least one line (row or column) of the current block may be obtained based on a prediction mode. Furthermore, prediction may be performed on the remaining pixels using prediction pixels for at least one line (row or column) of a current block.

The encoder may generate a difference signal based on the prediction pixels of the current block (S1530). In this case, the difference signal may be obtained by subtracting a prediction pixel value from the original pixel value.

The encoder may generate a transform-coded residual signal by applying a horizontal-directional transform matrix and/or a vertical-directional transform matrix to the difference signal (S1540). In this case, when the current block has a N×N size, the horizontal-directional transform matrix and/or the vertical-directional transform matrix may be N×N transform.

Meanwhile, the encoder may perform quantization on the transform-coded residual signal and perform entropy encoding on the quantized residual signal. In this case, rate-distortion optimized quantization may be applied to the step of performing the quantization.

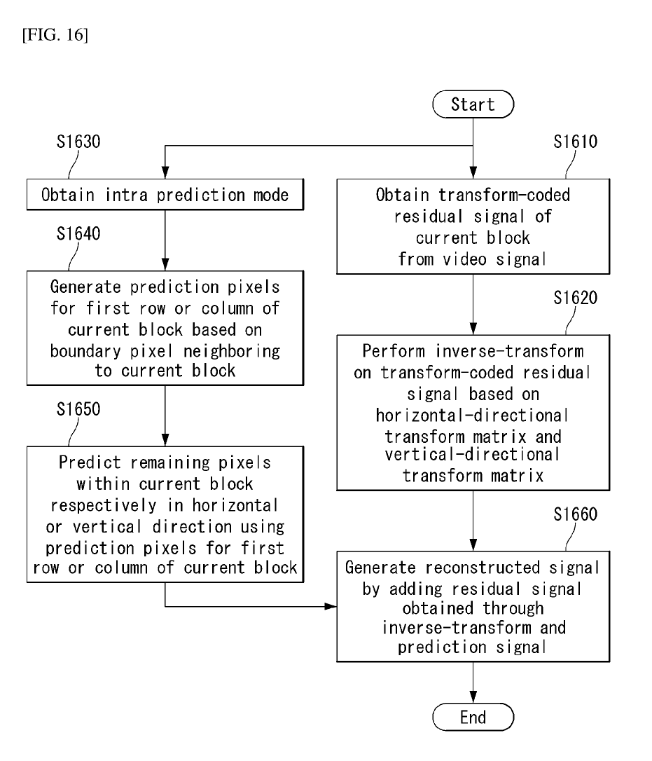

FIG. 16 is an embodiment to which the present invention is applied and is a flowchart for illustrating a method of decoding a current block using separable conditionally non-linear transform (SCNT).

The present invention provides a method of performing decoding based on a transform coefficient according to the separable conditionally non-linear transform (SCNT).

First, the decoder may obtain the transform-coded residual signal of a current block from a video signal (S1610).

The decoder may perform inverse transform on the transform-coded residual signal based on a vertical-directional transform matrix and/or a horizontal-directional transform matrix (S1620). In this case, the transform-coded residual signal may be sequentially inverse-transformed in a vertical direction and a horizontal direction. Furthermore, when the current block has a N×N size, the horizontal-directional transform matrix and the vertical-directional transform matrix may be a N×N transform.

Meanwhile, the decoder may obtain an intra-prediction mode from the video signal (S1630).

The decoder may generate prediction pixels for the first row or column of a current block using a boundary pixel neighboring to the current block based on the intra-prediction mode (S1640).

For example, if the prediction pixels for the first row of the current block have been obtained, the prediction for the remaining pixels may be performed based on a previously reconstructed pixel in the vertical direction. Alternatively, if the prediction pixels for the first column of the current block have been obtained, the prediction for the remaining pixels may be performed based on a previously reconstructed pixel in the horizontal direction.

Furthermore, when the current block has a N×N size, the boundary pixel neighboring to the current block may include at least one of N samples neighboring to the left boundary of the current block, N samples neighboring to the bottom left of the current block, N samples neighboring to the top boundary of the current block, N samples neighboring to the top right of the current block, and one sample neighboring to the top left corner of the current block.

The decoder may perform a prediction on the remaining pixels within the current block respectively in the vertical direction or the horizontal direction using the prediction pixels for the first row or column of the current block (S1650).

The decoder may generate a reconstructed signal by adding the residual signal obtained through the inverse transform and a prediction signal (S1660).

In other embodiments to which the present invention is applied, a CNT flag indicating whether the CNT will be applied may be defined. For example, the CNT flag may be expressed as CNT_flag. When CNT_flag is 1, it indicates that the CNT is applied to a current processing unit. When CNT_flag is 0, it indicates that the CNT is not applied to a current processing unit.

The CNT flag may be transmitted to the decoder. The CNT flag is extracted from at least one of a sequence parameter set (SPS), a picture parameter set (PPS), a slice, a coding unit (CU), a prediction unit (PU), a block, a polygon and a processing unit.

In other embodiments to which the present invention is applied, if only a prediction mode for the vertical or horizontal direction is used up to boundary pixels within a block, a construction is possible so that only a flag indicative of the vertical direction or the horizontal direction is transmitted without a need to transmit all of intra-prediction modes if the CNT is applied. In the CNT, a row direction transform kernel and a column direction transform kernel may also be applied to other transform kernels in addition to DCT and DST.

Furthermore, if a kernel other than DCT/DST is used, information about a corresponding transform kernel may be additionally transmitted. For example, if the transform kernel is defined as a template index, the template index may be transmitted to the decoder.

In other embodiments to which the present invention is applied, an SCNT flag indicating whether the SCNT will be applied may be defined. For example, the SCNT flag may be expressed as SCNT_flag. When SCNT_flag is 1, it indicates that the SCNT is applied to a current processing unit. When the SCNT_flag is 0, it indicates that the SCNT is not applied to a current processing unit.

The SCNT flag may be transmitted to the decoder. The CNT flag is extracted from at least one of a sequence parameter set (SPS), a picture parameter set (PPS), a slice, a coding unit (CU), a prediction unit (PU), a block, a polygon and a processing unit.

As described above, the embodiments described in the present invention may be performed by implementing them on a processor, a microprocessor, a controller or a chip. For example, the functional units depicted in FIGS. 1, 2, 3 and 4 may be performed by implementing them on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional (3D) video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method of encoding a video signal, comprising:
generating prediction pixels for a first row or column of a current block based on a boundary pixel neighboring to the current block;
predicting remaining pixels within the current block respectively in a vertical direction or a horizontal direction using the prediction pixels for the first row or column of the current block;
generating a difference signal based on the prediction pixels of the current block; and
generating a transform-coded residual signal by applying a horizontal-directional transform matrix and a vertical-directional transform matrix to the difference signal.

2. The method of claim 1,
wherein when the prediction pixels for the first row of the current block are generated, the prediction for the remaining pixels is performed based on a previously reconstructed pixel in the vertical direction.

3. The method of claim 1,
wherein when the prediction pixels for the first column of the current block are generated, the prediction for the remaining pixels is performed based on a previously reconstructed pixel in the horizontal direction.

4. The method of claim 1, further comprising:
performing a quantization on the transform-coded residual signal; and
performing an entropy encoding on the quantized residual signal.

5. The method of claim 2,
wherein a Rate-Distortion optimized quantization is applied to the step of performing the quantization.

6. The method of claim 1, further comprising:
determining an intra-prediction mode of the current block,
wherein the prediction pixels for the first row or column of the current block are generated based on the intra-prediction mode.

7. The method of claim 1,
wherein when the current block has a N×N size, the boundary pixel neighboring to the current block comprises at least one of N samples neighboring to a left boundary of the current block, N samples neighboring to a bottom left of the current block, N samples neighboring to a top boundary of the current block, N samples neighboring to a top right of the current block, and one sample neighboring to a top left corner of the current block.

8. The method of claim 1,
wherein when the current block has a N×N size, the horizontal-directional transform matrix and the vertical-directional transform matrix are a N×N transform.

9. A method of decoding a video signal, comprising:
obtaining a transform-coded residual signal of a current block from the video signal;
performing inverse transform on the transform-coded residual signal based on a vertical-directional transform matrix and a horizontal-directional transform matrix;
generating a prediction signal of the current block; and
generating a reconstructed signal by adding the residual signal obtained through the inverse transform and the prediction signal,
wherein the transform-coded residual signal is sequentially inverse-transformed in a vertical direction and a horizontal direction.

10. The method of claim 9,
wherein the step of generating the prediction signal comprises:
generating prediction pixels for a first row or column of the current block based on a boundary pixel neighboring to the current block; and
predicting remaining pixels within the current block respectively in the vertical direction or the horizontal direction using the prediction pixels for the first row or column of the current block.

11. The method of claim 10,
wherein when the prediction pixels for the first row of the current block are generated, the prediction for the remaining pixels is performed based on a previously reconstructed pixel in the vertical direction.

12. The method of claim 10,
wherein when the prediction pixels for the first column of the current block are generated, the prediction for the remaining pixels is performed based on a previously reconstructed pixel in the horizontal direction.

13. The method of claim 10, further comprising:
obtaining an intra-prediction mode of the current block,
wherein the prediction pixels for the first row or column of the current block are generated based on the intra-prediction mode.

14. The method of claim 10,
wherein when the current block has a N×N size, the boundary pixel neighboring to the current block comprises at least one of N samples neighboring to a left boundary of the current block, N samples neighboring to a bottom left of the current block, N samples neighboring to a top boundary of the current block, N samples neighboring to a top right of the current block and one sample neighboring to a top left corner of the current block.

15. The method of claim 9,
wherein when the current block has a N×N size, the horizontal-directional transform matrix and the vertical-directional transform matrix are a N×N transform.
